(19) United States
(12) Patent Application Publication
(10) Pub. No.: US 2019/0063390 A1
(43) Pub. Date: Feb. 28, 2019

(54) FUEL INJECTOR

(71) Applicant: Robert Bosch GmbH, Stuttgart (DE)

(72) Inventors: Frank Stadler, Stuttgart-Feuerbach (DE); Gerd Schweizer, Leinfelden-Echterdingen (DE); Ilias Sarisavvidis, Stuttgart (DE); Kristijan Vonic, Stuttgart (DE)

(21) Appl. No.: 16/061,703

(22) PCT Filed: Nov. 15, 2016
(86) PCT No.: PCT/EP2016/077734

§ 371 Date: Oct. 18, 2018

(30) Foreign Application Priority Data
Dec. 14, 2015 (DE) 10 2015 225 055.5

(51) Int. Cl. F02M 61/14; F02M 53/04; F02M 61/16

(52) U.S. Cl. CPC F02M 61/14; F02M 53/046; F02M 61/166; F02M 2200/858; F02M 2200/05; F02M 2200/8084; F02M 61/168

(57) ABSTRACT

The invention relates to a fuel injector (10), in particular a common-rail injector, comprising a valve housing (11) which can be inserted into a first receiving bore section (107) of an internal combustion machine and which has a first valve housing section (12) that faces a combustion chamber (101) of an internal combustion engine in the assembled position, said valve housing section being in contact with the combustion chamber (101) at least in some regions. At least the first valve housing section (12) consists of metal, and the first valve housing section (12) is radially surrounded by a protective element (20) in the form of a protective sleeve (21). The protective sleeve (21) extends at least over a part of the axial length of the first valve housing section (12). According to the invention, the transition region between the protective sleeve (21) and the first valve housing section (12) is sealed on the protective sleeve (21) side paired with the combustion chamber (101).

### BACKGROUND OF THE INVENTION

The invention relates to a fuel injector.

A fuel injector is known from DE 10 2012 205 699 A1 by the applicant. The known fuel injector is distinguished by the fact that a (sacrificial) protective sleeve consisting of metal is arranged on the outer circumference of its valve housing section facing the combustion chamber of an internal combustion engine. The background reason for this is that the highest temperature is found in the combustion chamber during the operation of the internal combustion engine and this gradually decreases in the cylinder head or in the location hole on the side facing away from the combustion chamber in accordance with the distance from the combustion chamber. Similarly, the temperature of the fuel injector or the valve housing thereof likewise decreases with increasing distance from the combustion chamber. Particularly at relatively low combustion chamber temperatures or at a relatively large distance from the combustion chamber, condensation with the risk of corrosion may occur on the valve housing, this being promoted inter alia by fuel containing sulfur. Since the valve housing is sealed off from the outside in the cylinder head of the internal combustion engine, usually by a nozzle sealing washer, this affects especially the region which is axially just below the nozzle sealing washer, in the region of a first location hole section of the cylinder head, since it is there, relatively speaking, that the lowest temperatures occur. By means of the (sacrificial) protective sleeve described in the cited application, it is possible to protect the valve housing at its outer circumference from access by the condensate and from corrosion.

In the case of the known fuel injector, the connection between the (sacrificial) protective sleeve and the fuel injector is achieved, in particular, by shrinking the (sacrificial) protective sleeve onto the outer circumference of the valve housing. The disadvantage here is that reliable prevention of access for condensate is not possible in the transitional region between the (sacrificial) protective sleeve and the valve housing on the side of the (sacrificial) protective sleeve facing the combustion chamber, despite the shrink-fitting of the protective sleeve. As a result, it is conceivable that condensate will penetrate into the radial interspace between the valve housing and the (sacrificial) protective sleeve and thereby lead to corrosion on the valve housing on the side of the fuel injector facing the combustion chamber.

DE 10 2012 219 654 A1 of the applicant furthermore discloses preventing the entry of condensate in the location hole of the cylinder head in the direction of the side facing away from the combustion chamber by means of a sealing element consisting of heat-resistant plastic or the like. In this case, the sealing element is secured or arranged on an additional element in the form of a sleeve, for example, in order to enable the sealing element to be positioned at the correct axial location on the valve housing. It is considered to be a critical factor in this fuel injector that the mounting of the fuel injector in the location hole is problematic owing to the required contact between the outer circumference of the sealing element and the location hole since damage to the sealing element must be reliably avoided. Moreover, the manufacture of a sealing element of this kind with an additional sleeve and the mounting thereof is relatively complex and expensive in comparison with the initially mentioned protective sleeve composed of copper.

### SUMMARY OF THE INVENTION

On the basis of the cited prior art, it is the underlying object of the invention to further develop a fuel injector in such a way that, with a relatively simple construction of the protective element and simple mounting of the protective element in terms of production engineering, an optimum sealing effect is achieved both on the fuel injector and on the side of the protective element facing the combustion chamber.

The invention is based on the concept of selectively sealing the (radial) region between the protective sleeve and the first valve housing section of the valve housing. Here, sealing in the sense according to the invention is understood to mean sealing which reliably prevents entry of condensate into the radial interspace between the protective sleeve and the valve housing on the side of the fuel injector facing the combustion chamber under a very wide variety of operating conditions, temperatures and pressures in the combustion chamber.

To achieve the desired sealing according to the invention between the protective element or protective sleeve and the valve housing section, it is envisaged, in a first embodiment of the invention, that a material joint in the form of a brazed joint is formed in the transitional region between the protective sleeve and the first valve housing section. Assuming a sufficiently high temperature resistance of the brazing solder, a brazed joint of this kind has the advantage, in particular, that the relevant components are subject to relatively low thermal stress during the formation of the seal. In particular, there is also no unwanted material modification (e.g. hardening, embrittlement or the like) in the valve housing or the protective sleeve due to the formation of a material joint of this kind.

As an alternative, it is also possible to envisage that a material joint in the form of a welded joint, in particular a laser weld seam, is formed in the transitional region between the protective sleeve and the first valve housing section. An embodiment of this kind has the advantage, in particular, that no additives such as those used in the formation of a brazed joint have to be used. Moreover, the mechanical strength between the protective sleeve and the valve housing is improved during the formation of a weld seam.

Common to both material joints is the fact that production tolerances between the protective element or protective sleeve and the valve housing section can be designed in such a way that, for example, relatively simple shrink-fitting of the protective sleeve onto the valve housing section is made possible. As a result, only relatively low axial forces are required when fitting the protective sleeve axially onto the valve housing section. The axial fixing or securing of the protective sleeve on the valve housing can then be accomplished by means of the brazed joint or weld seam mentioned, for example. In extreme cases, an embodiment of this kind even makes it possible to dispense with pressing of the protective sleeve onto the valve housing section.

Nevertheless, a preferred embodiment of the joint between the protective sleeve and the valve housing envisages that the protective sleeve is pressed onto the first valve housing section.

In order to be able to introduce the forces to be transmitted, particularly during the pressing on or fitting of the protective sleeve onto/on the valve housing section into the protective sleeve in an effective way, it is envisaged that the protective sleeve has a radially encircling flange on the side facing away from the combustion chamber. The flange can thus be used as a tool engagement surface for the transmission of the axial fitting force. The flange furthermore makes it possible to dispense with a separate sealing washer as in the prior art mentioned at the outset. In this case, the sealing of the mounted fuel injector with respect to the combustion chamber is performed by the flange of the protective sleeve.

Particularly simple mounting of the fuel injector in the location hole of the cylinder head can be achieved if the protective element has a diameter or shape such that a radial gap is formed between the protective element and the first location hole section in the cylinder head.

### BRIEF DESCRIPTION OF THE DRAWINGS

Further advantages, features and details of the invention will become apparent from the following description of preferred illustrative embodiments and from the drawing.

In the drawing:

FIG. 1 shows an illustration of a lower part of a fuel injector according to the invention, in which said injector is arranged in a cylinder head of an internal combustion engine,

FIG. 2 shows a protective element used in the fuel injector according to FIG. 1 in an isolated illustration in side view, and

FIG. 3 shows the fuel injector according to FIG. 1, in which a welded joint is formed between the valve housing and a protective element, in side view.

### DETAILED DESCRIPTION

Identical elements or elements with the same function are provided with the same reference numerals in the figures.

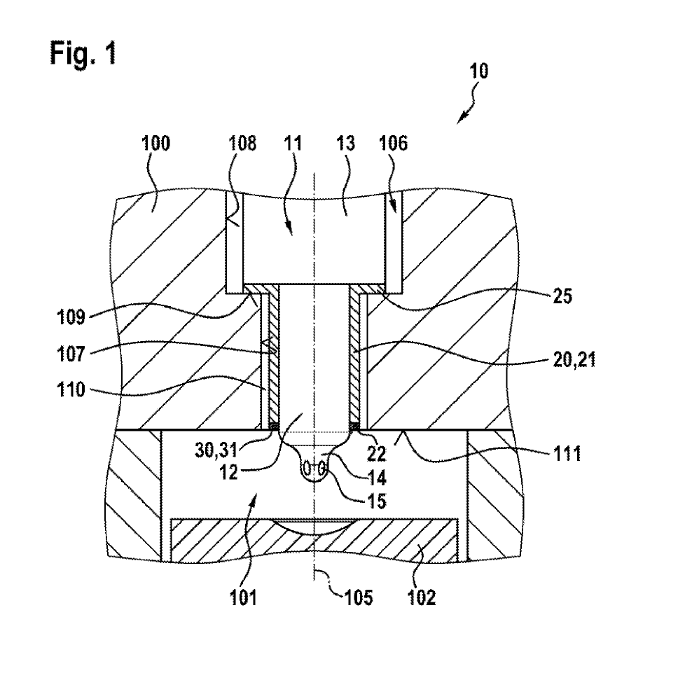

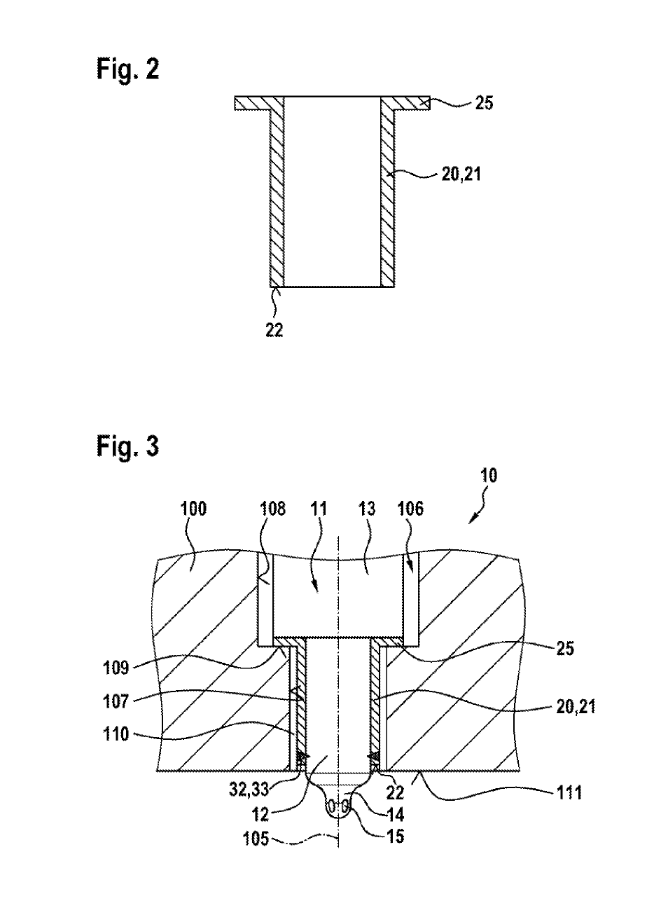

In FIG. 1, the upper region of an internal combustion engine having a cylinder head 100 is shown in a detail view. The cylinder head 100 delimits a combustion chamber 101 of the internal combustion engine, in which a piston 102 is arranged in such a way that it can move up and down in a conventional manner in the direction of a longitudinal axis 105.

To accommodate a fuel injector 10 according to the invention, in particular a common rail injector, the cylinder head 100 has a location opening 106 in the form of a stepped hole. On the side facing the combustion chamber 101, the location opening 106 has a first location hole section 107, adjoining which on the side facing away from the combustion chamber 101 is a second location hole section 108. The two location hole sections 107, 108 are connected to one another by a radially encircling step 109, wherein the first location hole section 107 has a smaller diameter than the second location hole section 108, and wherein the two location hole sections 107, 108 are each preferably of cylindrical design.

The fuel injector 10, which is illustrated in highly simplified form in FIG. 1, comprises a valve housing 11 consisting of metal and having two valve housing sections 12, 13 connected integrally to one another. The first valve housing section 12 has a smaller diameter than the second valve housing section 13, wherein the two valve housing sections 12, 13 are of at least approximately cylindrical design. The first valve housing section 12 is arranged substantially within the first location hole section 107, and the second valve housing section 13 is arranged within the second location hole section 108. On the side facing the combustion chamber 101, the first valve housing section 12 merges into an end region 14, which is dome-like in diameter and in the wall of which at least one nozzle opening 15 is formed, via which fuel can be injected into the combustion chamber 101 of the internal combustion engine. The fuel is injected in a manner which is known per se and is therefore not explained in detail because it is not essential to the invention by means, in particular, of a nozzle needle, which is arranged in the fuel injector 10 and can be actuated by an actuator.

While the first valve housing section 12 is arranged within the first location hole section 107, the end region 14 of the valve housing 11 projects into the combustion chamber 101. In this case, by way of example, the arrangement of the fuel injector 10 with respect to the combustion chamber 101 or to the longitudinal axis 105 is parallel to the longitudinal axis 105.

In order to allow leaktight mounting of the fuel injector 10 in the location opening 106 in the cylinder head 100, the fuel injector 10 is arranged in the location opening 106 with the interposition of a flange 25 of a protective element 20. For this purpose, the flange 25 rests by means of a (lower) end face on the step 109. The other (upper) end face of the flange 25 is in contact with a facing end face of the fuel injector 10. For sealing, provision is made in a conventional manner for the fuel injector 10 to be subjected to a force toward the combustion chamber 101 in the axial direction, e.g. by means of a clamp (not shown) or the like.

During the operation of the internal combustion engine, there is a relatively high temperature of, for example, a few hundred degrees Celsius within the combustion chamber 101, and this is transferred to the cylinder head 100 and to the fuel injector 10, wherein the temperature decreases in the region of the location hole 106 in the direction of the second location hole section 108 owing to the cooling of the cylinder head 100. To avoid the valve housing 11 being damaged by corrosion, when considered over the operating life of the fuel injector 10, in the region of the first valve housing section 12 on the side facing away from the combustion chamber 101, in which the lowest temperatures occur in relative terms, provision is made for the first valve housing section 12 to be radially surrounded by the protective element 20. The protective element 20 is designed as a separate component in the form of a protective sleeve 21.

By way of example, the protective sleeve 21 is of cylindrical design with a constant wall thickness and is pressed onto the outside diameter or outer circumference of the first valve housing section 12 by virtue of appropriate dimensional tolerancing. A radial gap 110 is furthermore formed between the outer circumference of the protective element 20 or protective sleeve 21 and the wall of the first location hole section 107, such that no contact occurs between the fuel injector 10 and the location hole section 107.

The protective element 20 or protective sleeve 21 consists of a higher-grade material than the material of the valve housing 11 or of the first valve housing section 12. A higher-grade material is taken to mean a material or substance which is less prone to corrosion than the (metallic) material of the valve housing 11. The protective element 20 or protective sleeve 21 preferably consists of a metal such as copper. The choice of suitable material for the protective element 20 depends, in particular but not by way of limitation, both on the wall thickness of the protective element 20 and on the prevailing combustion chamber temperatures as well as the material of the valve housing 11, and is chosen so that the corrosion which occurs on the protective element 20 during the planned operating life of the fuel injector 10 has as far as possible not progressed as far as the valve housing 11 or the first valve housing section 12 by the end of the operating life of the fuel injector 10.

It can be seen from FIG. 1 that the (lower) end face 22 of the protective element 20 or protective sleeve 21, that facing the combustion chamber 101, ends axially above the lower end face 111 of the cylinder head 100 in the region of the location opening 106. The essential point is that, at the maximum, the lower end face 22 ends flush with the lower end face 111 of the cylinder head 10, that is to say that the protective element 20 or protective sleeve 21 never projects into the combustion chamber 101.

As can be seen, in particular, from FIG. 1, the radial transitional region between the protective sleeve 21 and the first valve housing section 12 is of sealed design. For this purpose, provision is made, in the illustrative embodiment shown in FIG. 1, for the end-facing transitional region to the valve housing section 12 to be provided with a material joint 30, in the form of a brazed joint 31 for example. In particular, the brazing solder of the brazed joint 31 fills any radial gaps present between the outer circumference of the valve housing section 12 and the inside diameter of the protective sleeve 21 on the side facing the combustion chamber 101.

In the illustrative embodiment shown in FIG. 3, in contrast, the material joint 30 between the protective sleeve 21 and the valve housing section 12 is in the form of a welded joint 32. The welded joint 32 comprises a weld seam 33, in particular in the form of a laser weld seam, radially encircling the outside of the protective sleeve 21. The weld seam 33 melts the material of the protective sleeve 21 and of the valve housing section 12 in the transitional region thereof and ensures the required sealing. The axial position of the weld seam 33 is as close as possible to the (lower) end face 22 of the protective sleeve 21.

The fuel injector 10 described thus far can be modified or changed in many different ways without departing from the concept of the invention.

1. A fuel injector (10), having a valve housing (11), which can be inserted into a first location hole section (107) of an internal combustion engine and which, in an installed position, has a first valve housing section (12) that faces a combustion chamber (101) of the internal combustion engine, said first valve housing section being in contact with the combustion chamber (101) at least in a region or regions, wherein at least the first valve housing section (12) consists of metal, wherein the first valve housing section (12) is radially surrounded by a protective element (20) in the form of a protective sleeve (21), and wherein the protective sleeve (21) extends at least over a part of an axial length of the first valve housing section (12), characterized in that a transitional region between the protective sleeve (21) and the first valve housing section (12) is sealed on a side of the protective sleeve (21) which is associated with the combustion chamber (101).

2. The fuel injector as claimed in claim 1, characterized in that a material joint (30) in the form of a brazed joint (31) is formed in the transitional region between the protective sleeve (21) and the first valve housing section (12).

3. The fuel injector as claimed in claim 1, characterized in that a material joint (30) in the form of a welded joint (33) is formed in the transitional region between the protective sleeve (21) and the first valve housing section (12).

4. The fuel injector as claimed in claim 1, characterized in that the protective sleeve (21) is pressed onto the first valve housing section (12).

5. The fuel injector as claimed in claim 1, characterized in that the protective sleeve (21) has a radially encircling flange (25) on a side facing away from the combustion chamber (101).

6. The fuel injector as claimed in claim 1, characterized in that the protective sleeve (21) consists of a material which has a lower susceptibility to corrosion than the material of the first valve housing section (12).

7. The fuel injector as claimed in claim 6, characterized in that the material of the protective sleeve (21) consists of metal and contains copper.

8. The fuel injector as claimed in claim 1, characterized in that the protective element (20) is configured such that a radial gap (110) is formed between the protective element (20) and the first location hole section (107).

9. The fuel injector as claimed in claim 1, characterized in that an axial length of the protective element (20) is smaller than the axial length of the first valve housing section (12), such that, with a fuel injector (10) mounted in the first location hole section (107), the protective element (20) does not project axially into the combustion chamber (101).

10. The fuel injector as claimed in claim 5, characterized in that a second valve housing section (13) of the valve housing (11) adjoins the flange (25) on a side facing away from the first valve housing section (12).

11. The fuel injector as claimed in claim 1, characterized in that a material joint (30) in the form of a laser weld seam is formed in the transitional region between the protective sleeve (21) and the first valve housing section (12).
